(19) United States
(12) Patent Application Publication
(10) Pub. No.: US 2015/0113571 A1
(43) Pub. Date: Apr. 23, 2015

(54) METHODS AND APPARATUS FOR CONTENT SWITCHING

(71) Applicant: Time Warner Cable Enterprises LLC, New York, NY (US)

(72) Inventors: Chris Cholas, Frederick, CO (US); Eric Hybertson, Longmont, CO (US); Greg Calvert, New York, NY (US)

(21) Appl. No.: 14/060,358

(22) Filed: Oct. 22, 2013

(51) Int. Cl. H04N 21/462; H04N 21/472

(52) U.S. Cl. CPC H04N 21/4622; H04N 21/47202
USPC 725/59

(57) ABSTRACT

Methods and apparatus for content switching in a content distribution network. In one embodiment, an apparatus is configured to receive a user selection for content. The apparatus processes the content and outputs the content to a display. The apparatus also receives an input indicating a content switch, and switches to an alternate content located on a second apparatus. The apparatus transmits the secondary content to the second apparatus, while receiving the alternate content from the second apparatus. In one aspect, the apparatus performs at least one of the following: provide a notification to a user when the secondary content has ended or automatically switch the alternate content back to the second apparatus while receiving the user selected content in response to detecting the end of the secondary content. Methods for content switching in a content switching in a content distribution network using the aforementioned apparatus are also disclosed.

### RELATED APPLICATIONS

The present application is related to co-owned and co-pending U.S. patent application Ser. No. 13/955,989 filed on Jul. 31, 2013 and entitled “METHODS AND APPARATUS THAT FACILITATE CHANNEL SWITCHING DURING COMMERCIAL BREAKS AND/OR OTHER PROGRAM SEGMENTS”, which is incorporated herein by reference in its entirety. This application is also related to U.S. patent application Ser. No. 12/631,713 filed on Dec. 4, 2009 and entitled “APPARATUS AND METHODS FOR MONITORING AND OPTIMIZING DELIVERY OF CONTENT IN A NETWORK”, which is now U.S. Patent Publication No. 2011/0138064 and U.S. patent application Ser. No. 12/783,388 filed on May 19, 2010 and entitled “METHODS AND APPARATUS FOR PACKETIZED CONTENT DELIVERY OVER A CONTENT DELIVERY NETWORK” which is now published as U.S. Patent Application Publication No. 2011/0107379, and patented as U.S. Pat. No. 8,516,529, each of which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Technological Field

The disclosure relates generally to the field of content and/or data delivery, such as via a content distribution (e.g., cable, satellite) or other network. In one exemplary aspect, the disclosure relates to the use of a network architecture for switching content delivery between devices and/or content sources.

2. Description of Related Technology

It is not uncommon for a user watching live television, or other content, to be confronted with advertisements while watching primary content such as movies, music videos, broadcast or live programming content, etc. The user entity providing the content, may require the content to be streamed in a linear fashion at or near the rate at which it is to be viewed either because of physical constraints, such as the fact that the content is being generated in real time such as in the case of sporting events, or for business reasons, e.g., to ensure that advertisements which are provided with the primary content are viewed.

The user is generally provided with few options with regard to advertisement breaks when attempting to watch primary content, e.g., desired content. One option users have, is to switch channels during the period of time an advertisement break is provided to the user's device. However, the user may not know precisely when the advertisement break is over, and therefore may miss a portion of the desired content being presented on the original channel (while he is tuned away). Another option users have, is to browse through a program guide and/or channel surf i.e., switch to various other channels while waiting for the advertisement to end. In this option, the only way to find out whether the advertisement break has ended, and the desired content has resumed, is to periodically switch back to the original channel that the user was watching prior to switching. In many cases, the length of the advertisement breaks is not constant and may vary and therefore, the user may have to re-tune to the original channel several times to check if the advertisements have ended. It is appreciated that neither method is precise and each requires significant amount of wasted time and/or effort on the part of the viewer.

In addition to browsing through a program guide the user may record the desired content and play it back at a later time allowing the user the opportunity to manually skip recorded commercials. However, this option is not feasible when the user wants to view content in real time. Also, hardware constraints (such as limited memory or storage and/or limited number of tuners of the device) may make recording a program in this manner difficult.

Yet another option is to view content on a second device. In other words, the second device displays different content than the first device such that, during the advertisement break at the first device, the user may direct their attention to the second device. Clearly, viewing content on a separate device gives rise to additional problems ranging from device and/or display size, conflicting audio, etc. Even on the second device, the user still has to direct their attention back and forth between the devices to check if the commercial has ended and the desired content has resumed, thus leaving a wide margin for error and missed content yet again.

Hence, generally during program advertisements, the user must watch the advertisements, manually switch back and forth between the advertisements and other channels, record the content to watch at a later time (skipping the advertisements via trick mode operations), or use a second device to display different content during the advertisements. None of the foregoing options presents an effective mechanism for accomplishing the desired goal of the viewer.

Therefore, what are needed are apparatus and methods for enabling a user to view content from a separate content source or channel while an advertisement break is being displayed on an original source or channel. Ideally, such methods and apparatus would provide a message or other notification to the viewer when the advertisement break on the original source or channel has ended. Alternatively, the methods and apparatus may automatically switch the display from the second displayed content to the originally selected content when the advertisements have ended.

### SUMMARY

The present disclosure addresses the foregoing needs by providing, in various embodiments, methods and apparatus for content switching.

In a first aspect, a method for managing content is disclosed. In one embodiment, the managing content occurs within a content distribution network, and the method includes: (i) receiving a user selection for content corresponding to primary content, (ii) outputting the primary content to a rendering apparatus, (iii) receiving an input indicating a content switch during rendering of secondary content to alternate content, and (iv) switching automatically from the alternate content back to the primary content in response to detecting the end of the secondary content.

In a second aspect, an apparatus for switching content is disclosed. In one embodiment, the apparatus includes a first interface configured to communicate with a network, a storage apparatus, and a processor configured to execute at least one computer program, the at least one computer program comprising a plurality of instructions which are configured to, when executed: (i) receive a request to switch during rendering of secondary content to alternate content, the alternate content associated with a second apparatus, (ii) transmit the secondary content to the second apparatus, (iii) receive the alternate content from the second apparatus, (iv) output to a rendering apparatus the alternate content, and (iv) switch automatically from the alternate content back to primary content in response to detecting the end of the secondary content.

In a third aspect of the disclosure, a computer readable apparatus is disclosed. In one embodiment, the computer readable apparatus having a storage medium including a plurality of instructions which are configured to, when executed: (i) receive user selected content, the user selected content including primary content and secondary content, (ii) output the primary content to a display rendering device, (iii) receive an input indicating a content switch during rendering of the secondary content to rendering of an alternate content located on a second apparatus, (iv) cause transmission of the secondary content to the second apparatus, (v) receive the alternate content from the second apparatus, (vi) cause rendering of the alternate content, and (vii) cause switching from the alternate content back to primary content in response to detecting the end of the secondary content.

In a fourth aspect of the disclosure, a method for managing content is disclosed. In one embodiment, the managing content occurs within a content distribution network, and the method includes: (i) receiving a user selection for content corresponding to primary content, (ii) outputting the primary content to a rendering apparatus, (iii) receiving an input indicating a content switch during rendering of secondary content to alternate content, and (iv) providing notification to a user indicating an end of the secondary content during the outputting of the alternate content.

In a fifth aspect of the disclosure, a system for managing content is disclosed. In one embodiment, the system includes a network content server configured to provide primary content and alternate content, from a content source to a first apparatus and a second apparatus in the user premises, and at least one apparatus is configured to run at least one manager application configured to: (i) monitor an input indicating a content switch during rendering of secondary content on the first apparatus to rendering of an alternate content located on the second apparatus, and (ii) switch automatically from the alternate content back to the primary content in response to detecting the end of the secondary content.

Other features and advantages of the present disclosure will immediately be recognized by persons of ordinary skill in the art with reference to the attached drawings and detailed description of exemplary embodiments as given below.

### BRIEF DESCRIPTION OF THE DRAWINGS

FIG. 1 is a functional block diagram illustrating an exemplary hybrid fiber network configuration useful with the present disclosure.

FIG. 1a is a functional block diagram illustrating one exemplary network headend configuration useful with the present disclosure.

FIG. 1b is a functional block diagram illustrating one exemplary local service node configuration useful with the present disclosure.

FIG. 1c is a functional block diagram illustrating one exemplary broadcast switched architecture (BSA) network useful with the present disclosure.

FIG. 1d is a functional block diagram illustrating one exemplary packetized content delivery network architecture useful with the present disclosure.

FIG. 2 is a functional block diagram illustrating one exemplary content switch distribution network architecture useful with the present disclosure.

FIG. 2a is a functional block diagram illustrating another exemplary content switch distribution network architecture useful with the present disclosure.

FIG. 3 is a logical flow diagram illustrating an exemplary embodiment of a generalized method for switching between different content sources according to the present disclosure.

FIGS. 3a-3c are logical flow diagrams illustrating another exemplary embodiment of a generalized method for switching between different content sources according to the present disclosure.

FIG. 4 is a functional block diagram illustrating an exemplary client device architecture.

All Figures © Copyright 2013 Time Warner Cable Enterprises LLC. All rights reserved.

### DETAILED DESCRIPTION

Reference is now made to the drawings wherein like numerals refer to like parts throughout.

As used herein, the term “application” refers generally to a unit of executable software that implements a certain functionality or theme. The themes of applications vary broadly across any number of disciplines and functions (such as on-demand content management, e-commerce transactions, brokerage transactions, home entertainment, calculator etc.), and one application may have more than one theme. The unit of executable software generally runs in a predetermined environment; for example, the unit could comprise a downloadable Java Xlet™ that runs within the JavaTV™ environment.

As used herein, the terms “client device” and “end user device” include, but are not limited to, set-top boxes (e.g., DSTBs), personal computers (PCs), and minicomputers, whether desktop, laptop, or otherwise, and mobile devices such as handheld computers, PDAs, personal media devices (PMDs), and smartphones.

As used herein, the term “codec” refers to an video, audio, or other data coding and/or decoding algorithm, process or apparatus including, without limitation, those of the MPEG (e.g., MPEG-1, MPEG-2, MPEG-4, etc.), Real (RealVideo, etc.), AC-3 (audio), DiVX, XViD/ViDX, Windows Media Video (e.g., WMV 7, 8, or 9), ATI Video codec, or VC-1 (SMPTE standard 421M) families.

As used herein, the term “computer program” or “software” is meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.), Binary Runtime Environment (e.g., BREW), and the like.

Similarly, the terms “Consumer Premises Equipment (CPE)” and “host device” refer without limitation to any type of electronic equipment located within a consumer's or user's premises and connected to a network. The term “host device” refers generally to a terminal device that has access to digital television content via a satellite, cable, or terrestrial network. The host device functionality may be integrated into a digital television (DTV) set. The term “consumer premises equipment” (CPE) includes such electronic equipment such as set-top boxes, televisions, Digital Video Recorders (DVR), gateway storage devices (Furnace), and ITV Personal Computers.

As used herein, the term “display” means any type of device adapted to display information, including without CRTs, LCDs, TFTs, plasma displays, LEDs, incandescent and fluorescent devices. Display devices may also include less dynamic devices such as, for example, printers, e-ink devices, and the like.

As used herein, the term “DOCSIS” refers to any of the existing or planned variants of the Data Over Cable Services Interface Specification, including for example DOCSIS versions 1.0, 1.1, 2.0 and 3.0.

As used herein, the term “headend” refers generally to a networked system controlled by an operator (e.g., an MSO or multimedia specific operator) that distributes programming to MSO clientele using client devices. Such programming may include literally any information source/receiver including, inter cilia, free-to-air TV channels, pay TV channels, interactive TV, and the Internet. DSTBs may literally take on any configuration, and can be retail devices meaning that consumers may or may not obtain their DSTBs from the MSO exclusively. Accordingly, it is anticipated that MSO networks may have client devices from multiple vendors, and these client devices will have widely varying hardware capabilities. Multiple regional headends may be in the same or different cities.

As used herein, the terms “Internet” and “interne” are used interchangeably to refer to inter-networks including, without limitation, the Internet.

As used herein, the terms “IP” and “Internet Protocol” refer without limitation to any of the Internet protocols including e.g., IPv4 (RFC-791 (1981), et seq.), and IPv6 (RFC-2460 (1998), et seq.).

As used herein, the term “memory” includes any type of integrated circuit or other storage device adapted for storing digital data including, without limitation, ROM. PROM, EEPROM, DRAM, SDRAM, DDR/2 SDRAM, EDO/FPMS, RLDRAM, SRAM, “flash” memory (e.g., NAND/NOR), and PSRAM.

As used herein, the terms “MSO” or “multiple systems operator” refer to a cable, satellite, or terrestrial network provider having infrastructure required to deliver services including programming and data over those mediums.

As used herein, the terms “network” and “bearer network” refer generally to any type of telecommunications or data network including, without limitation, hybrid fiber coax (HFC) networks, satellite networks, telco networks, and data networks (including MANs, WANs, LANs, WLANs, internets, and intranets). Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, ATM, X.25, Frame Relay, 3GPP, 3GPP2, WAP, SIP, UDP, FTP, RTP/RTCP, H.323, etc.).

As used herein, the term “network interface” refers to any signal, data, or software interface with a component, network or process including, without limitation, those of the Firewire (e.g., FW400, FW800, etc.), USB (e.g., USB2), Ethernet (e.g., 10/100, 10/100/1000 (Gigabit Ethernet), 10-Gig-E, etc.), MoCA, Serial ATA (e.g., SATA, e-SATA, SATAII), Ultra-ATA/DMA, Coaxsys (e.g., TVnet™), radio frequency tuner (e.g., in-band or OOB, cable modem, etc.), WiFi (802.11a,b,g,n), WiMAX (802.16), PAN (802.15), or IrDA families.

As used herein, the term “node” refers without limitation to any location, functional entity, or component within a network.

As used herein, the term “QAM” refers to modulation schemes used for sending signals over cable networks. Such modulation scheme might use any constellation level (e.g. QPSK, QAM-16, QAM-64, QAM-256 etc.) depending on details of a cable network. A QAM may also refer to a physical channel modulated according to the schemes.

As used herein, the term “server” refers to any computerized component, system or entity regardless of form which is adapted to provide data, files, applications, content, or other services to one or more other devices or entities on a computer network.

As used herein, the term “storage device” refers to without limitation computer hard drives, DVR device, memory, RAID devices or arrays, optical media (e.g., CD-ROMs, Laserdiscs, Blu-Ray, etc.), or any other devices or media capable of storing content or other information.

As used herein, the term “user interface” refers to, without limitation, any visual, graphical, tactile, audible, sensory, or other means of providing information to and/or receiving information from a user or other entity.

As used herein, the term “wireless” means any wireless signal, data, communication, or other interface including without limitation Wi-Fi, Bluetooth, 3G (3GPP/3GPP2), HSDPA/HSUPA, TDMA, CDMA (e.g., IS-95A, WCDMA, etc.), FHSS, DSSS, GSM, PAN/802.15, WiMAX (802.16), 802.20, Zigbee, narrowband/FDMA, OFDM, PCS/DCS, LTE/LTE-A, analog cellular, CDPD, satellite systems, millimeter wave or microwave systems, acoustic, and infrared (i.e., IrDA).

### Overview

The present disclosure provides, inter alfa, methods and apparatus for content switching between at least two apparatus. In one aspect, the present disclosure provides a first apparatus (such as a server, or client device) which is configured to receive a user request for a first content element; the first content element is processed and outputted to a display associated with the first apparatus. While the first content is displayed, the first apparatus receives an indication (during a particular content segment, i.e., an advertisement or secondary content segment) indicating a request to switch to alternate content. The first apparatus tunes to the alternate content, processes the alternate content, and outputs the alternate content to the display. The first apparatus further performs at least one of the following during the display of the alternate content: (i) provides a notification to a viewer indicating an end of the advertising or secondary content segment; or (ii) automatically switch from the alternate content back to the originally requested first content.

The foregoing is accomplished, in one implementation, by receiving the alternate content from a second apparatus. In this implementation, the first apparatus transmits advertisement or secondary content to the second apparatus for display thereat. Simultaneously, the second apparatus transmits the alternate content to the first apparatus for display thereat.

In another embodiment, the first apparatus is further configured to monitor the original or first content for a start marker and an end marker corresponding to the respective start and end of the secondary content segment within the original content. According to this implementation, detection of the start marker initiates a switch of which device displays which content; and detection of the end marker initiates delivery of a notification, and/or an automatic return of the devices to the content they had displayed (previous to the first switch).

In one variant, either device may be further configured to record the original or primary content when the switch back to the original content at the first apparatus is delayed. In other words, the viewer may delay switching back to the original content after the secondary content segment has ended, such as when the alternate content continues to be of interest and it is desired to keep the alternate content displayed at the first apparatus a while longer. In this case, the first or second apparatus may begin recording the content (starting at the end of the secondary content segment) and provide the user the ability to resume the original content from the point where the apparatus began recording.

In another variant, the first and/or second apparatus may be further configured to provide the user a variety of options when switching between original and alternate content at the various devices. For example, an option to watch a modified or condensed version, e.g., compilation, of the alternate content (such as highlights), may be given. In one embodiment, the modified or condensed version of the alternate corresponds to portions of the alternate content which were displayed at the second device when the original content was displayed on the first apparatus.

Methods of operating the network(s), client devices, and for doing business using the network referenced above, are also described.

### DETAILED DESCRIPTION OF EXEMPLARY EMBODIMENTS

Exemplary embodiments of the apparatus and methods of the disclosure are now described in detail. While these exemplary embodiments are described in the context of the aforementioned hybrid fiber coax (HFC) cable system architecture having a multiple systems operator (MSO), digital networking capability, IP delivery capability, and plurality of client devices/CPE, the general principles and advantages of the present disclosure may be extended to other types of networks and architectures, whether broadband, narrowband, wired or wireless, managed or unmanaged, or otherwise, the following therefore being merely exemplary in nature.

It will also be appreciated that while described generally in the context of a consumer (i.e., home) end user domain, the present disclosure may be readily adapted to other types of environments (e.g., commercial/enterprise, government/military, etc.) as well. Myriad other applications are possible.

Also, while certain aspects are described primarily in the context of the well-known Internet Protocol, it will be appreciated that the present disclosure may utilize other types of protocols (and in fact bearer networks to include other internets and intranets) to implement the described functionality.

Other features and advantages of the present disclosure will immediately be recognized by persons of ordinary skill in the art with reference to the attached drawings and detailed description of exemplary embodiments as given below.

### Network-Side Architecture—

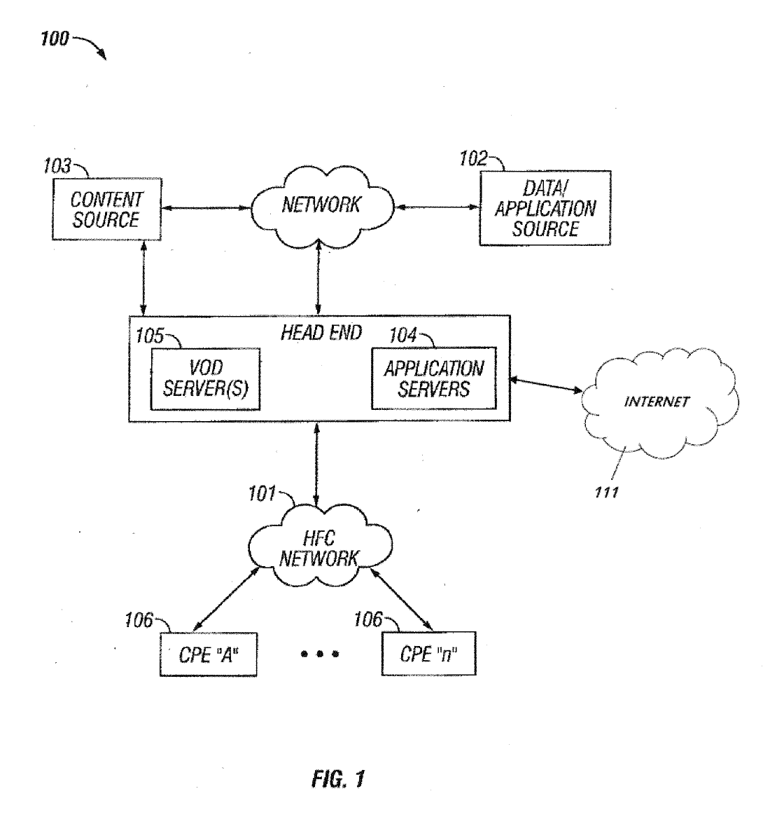

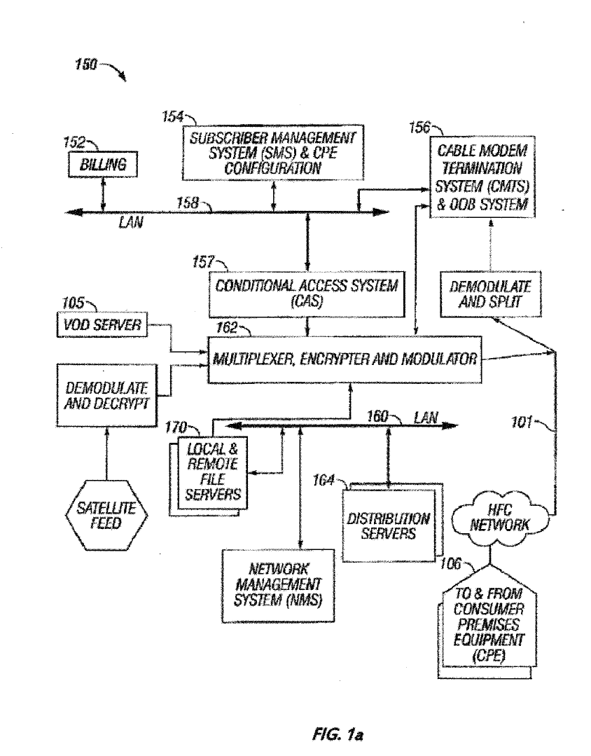

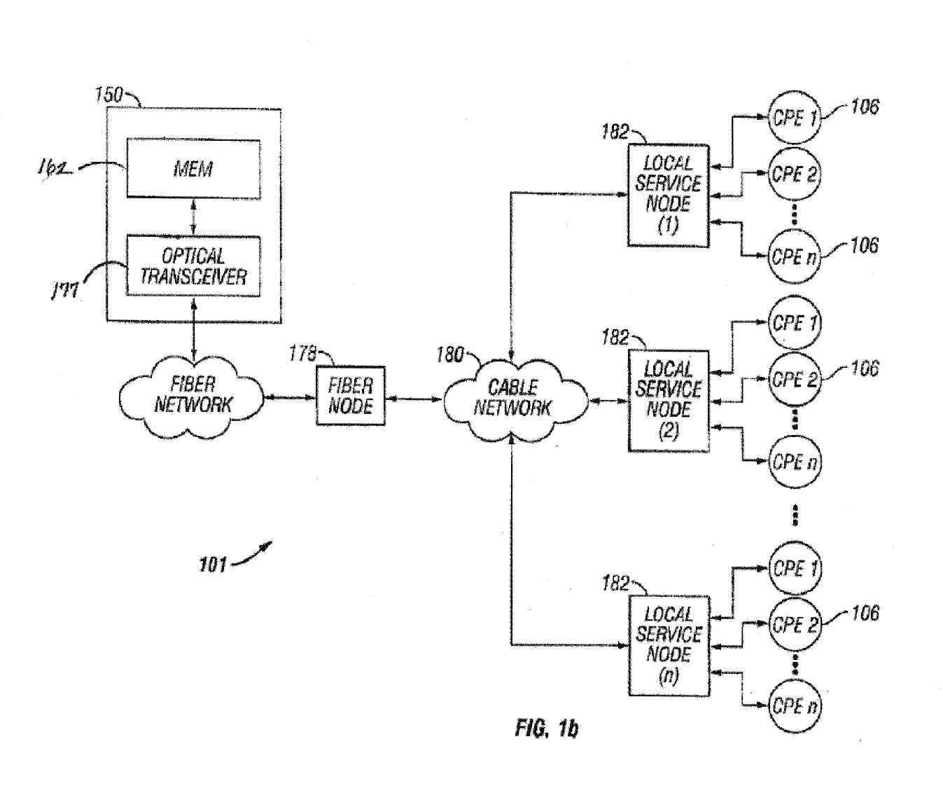

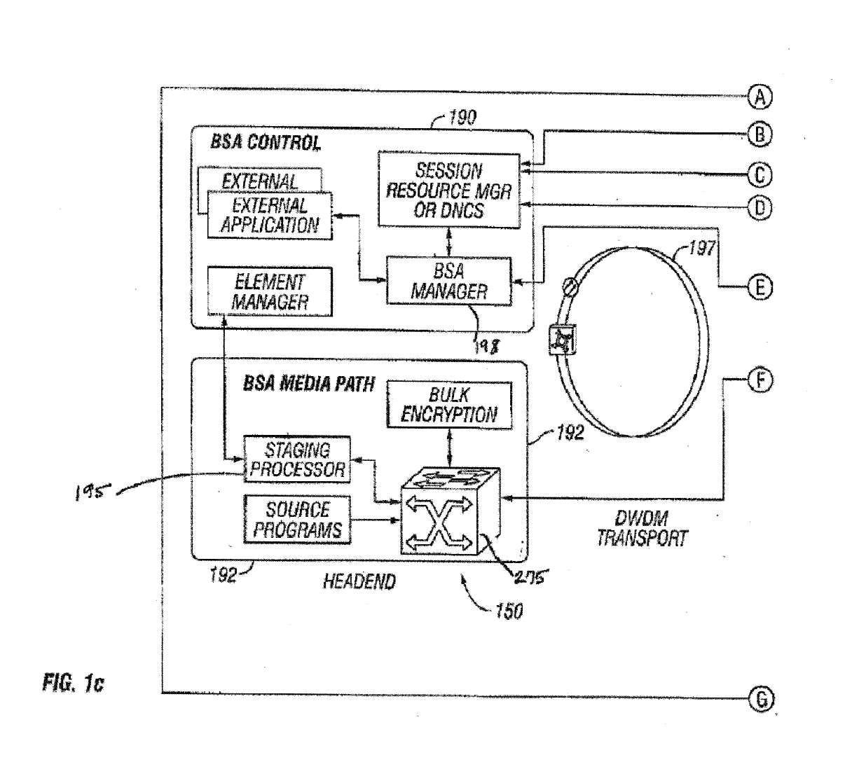

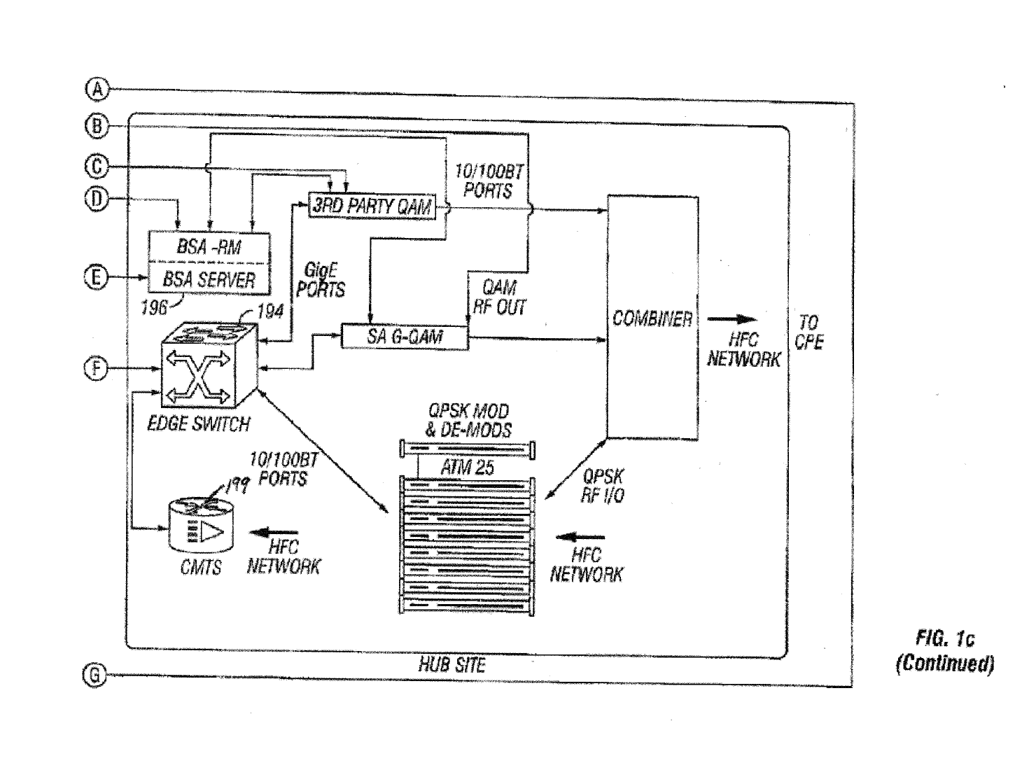

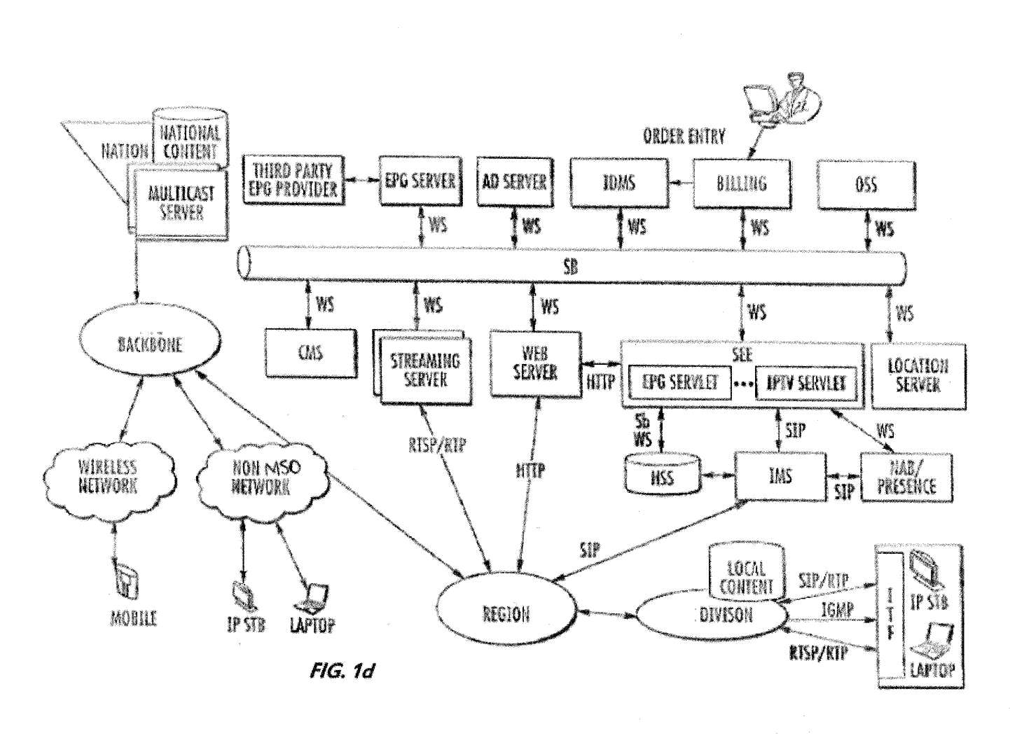

FIG. 1 illustrates a typical content delivery network configuration with which the exemplary apparatus and methods of the present disclosure may be used. The various components of the network 100 include (i) one or more data and application origination points 102; (ii) one or more content sources 103, (iii) one or more application distribution servers 104; (iv) one or more VOD servers 105, and (v) client devices or customer premises equipment (CPE) 106. The distribution server(s) 104, VOD servers 105 and CPE(s) 106 are connected via a bearer (e.g., HFC) network 101 (also referred to herein as a content delivery network (CDN)). The headend is also connected through a gateway or other such interface (not shown) to unmanaged external internetworks such as the Internet 111.

A simple architecture comprising one of each of the aforementioned components 102, 104, 105, 106 is shown in FIG. 1 for simplicity, although it will be recognized that comparable architectures with multiple origination points, distribution servers, VOD servers, and/or CPE devices (as well as different network topologies) may be utilized consistent with the disclosure. For example, the headend architecture of FIG. 1a (described in greater detail below) may be used.

The data/application origination point 102 comprises any medium that allows data and/or applications (such as a VOD-based or “Watch TV” application) to be transferred to a distribution server 104. This can include for example a third party data source, application vendor website, CD-ROM, external network interface, mass storage device (e.g., RAID system), etc. Such transference may be automatic, initiated upon the occurrence of one or more specified events (such as the receipt of a request packet or ACK), performed manually, or accomplished in any number of other modes readily recognized by those of ordinary skill.

The application distribution server 104 comprises a computer system where such applications can enter the network system. Distribution servers are well known in the networking arts, and accordingly not described further herein.

The VOD server 105 comprises a computer system where on-demand content can be received from one or more of the aforementioned data sources 102 and enter the network system. These servers may generate the content locally, or alternatively act as a gateway or intermediary from a distant source.

The CPE 106 includes any equipment in the “customers' premises” (or other locations, whether local or remote to the distribution server 104) that can be accessed by a distribution server 104. As will be discussed in greater detail below, in one embodiment the CPE may include IP-enabled CPE 107 (although not illustrated in FIGS. 1-1d), and a gateway or specially configured modem (e.g., DOCSIS cable modem).

Referring now to FIG. 1a, one exemplary embodiment of a headend architecture useful with the present disclosure is described. As shown in FIG. 1a, the headend architecture 150 comprises typical headend components and services including billing module 152, subscriber management system (SMS) and CPE configuration management module 154, cable-modem termination system (CMTS) and OOB system 156, as well as LAN(s) 158, 160 placing the various components in data communication with one another. It will be appreciated that while a bar or bus LAN topology is illustrated, any number of other arrangements as previously referenced (e.g., ring, star, etc.) may be used consistent with the disclosure. It will also be appreciated that the headend configuration depicted in FIG. 1a is high-level, conceptual architecture and that each MSO may have multiple headends deployed using custom architectures.

The exemplary architecture 150 of FIG. 1a further includes a multiplexer-encrypter-modulator (MEM) 162 coupled to the HFC network 101 adapted to process or condition content for transmission over the network. The distribution servers 164 are coupled to the LAN 160, which provides access to the MEM 162 and network 101 via one or more file servers 170. The VOD servers 105 are coupled to the LAN 160 as well, although other architectures may be employed (such as for example where the VOD servers are associated with a core switching device such as an 802.3z Gigabit Ethernet device). As previously described, information is carried across multiple channels. Thus, the headend must be adapted to acquire the information for the carried channels from various sources. Typically, the channels being delivered from the headend 150 to the CPE 106 (“downstream”) are multiplexed together in the headend, as previously described and sent to neighborhood hubs (FIG. 1b) via a variety of interposed network components.

It will also be recognized, however, that the multiplexing operation(s) need not necessarily occur at the headend 150 (e.g., in the aforementioned MEM 162). For example, in one variant, at least a portion of the multiplexing is conducted at a BSA/SDV switching node or hub (see discussion of FIG. 1c provided subsequently herein). As yet another alternative, a multi-location or multi-stage approach can be used, such as that described in U.S. Pat. No. 7,602,820, entitled “APPARATUS AND METHODS FOR MULTI-STAGE MULTIPLEXING IN A NETWORK” incorporated herein by reference in its entirety, which discloses, inter cilia, improved multiplexing apparatus and methods that allow such systems to dynamically compensate for content (e.g., advertisements, promotions, or other programs) that is inserted at a downstream network node such as a local hub, as well as “feed-back” and “feed forward” mechanisms for transferring information between multiplexing stages.

Content (e.g., audio, video, data, files, etc.) is provided in each downstream (in-band) channel associated with the relevant service group. To communicate with the headend or intermediary node (e.g., hub server), the CPE 106 may use the out-of-band (OOB) or DOCSIS channels and associated protocols. The OCAP 1.0 (and subsequent) specification provides for exemplary networking protocols both downstream and upstream, although the disclosure is in no way limited to these approaches.

It will also be recognized that the multiple servers (broadcast, VOD, or otherwise) can be used, and disposed at two or more different locations if desired, such as being part of different server “farms”. These multiple servers can be used to feed one service group, or alternatively different service groups. In a simple architecture, a single server is used to feed one or more service groups. In another variant, multiple servers located at the same location are used to feed one or more service groups. In yet another variant, multiple servers disposed at different location are used to feed one or more service groups.

An optical transport ring (not shown) is also commonly utilized to distribute the dense wave-division multiplexed (DWDM) optical signals to each hub within the network in an efficient fashion.

### “Switched” Networks—

FIG. 1c illustrates an exemplary “switched” network architecture. While a so-called “broadcast switched architecture” (BSA), also known as “switched digital video” or “SDV”, network is illustrated in this exemplary embodiment for performing bandwidth optimization/conservation functions, it will be recognized that the present disclosure is in no way limited to such architectures.

Switching architectures allow improved efficiency of bandwidth use for ordinary digital broadcast programs. Ideally, the subscriber will be unaware of any difference between programs delivered using a switched network and ordinary streaming broadcast delivery.

FIG. 1c shows the implementation details of one exemplary embodiment of this broadcast switched network architecture. Specifically, the headend 150 contains switched broadcast control and media path functions 190, 192; these elements cooperate to control and feed, respectively, downstream or edge switching devices 194 at the hub site which are used to selectively switch broadcast streams to various service groups. A BSA or SDV server 196 is also disposed at the hub site, and implements functions related to switching and bandwidth conservation (in conjunction with a management entity 198 disposed at the headend). An optical transport ring 197 is utilized to distribute the dense wave-division multiplexed (DWDM) optical signals to each hub in an efficient fashion.

U.S. Patent Application Publication No. 2003/0056217, entitled “TECHNIQUE FOR EFFECTIVELY PROVIDING PROGRAM MATERIAL IN A CABLE TELEVISION SYSTEM”, published Mar. 20, 2003, describes one exemplary broadcast switched digital architecture useful with the present disclosure, although it will be recognized by those of ordinary skill that other approaches and architectures may be substituted.

A primary advantage of the BSA paradigm is bandwidth conservation/preservation. Bandwidth for unviewed programs is not consumed, and can be re-allocated. Similarly, new programs can be added without adding bandwidth. Advantageously, programs with narrow appeal can be added in the BSA system with little if any bandwidth impact. More popular programs will impact the BSA bandwidth, but to a lesser extent than was traditionally the case. Multiple bitrates can also be made available for use or sale to programmers or advertisers.

In one exemplary embodiment, the methods and apparatus of co-owned, co-pending U.S. Patent Publication No. 2012/0023535 entitled “APPARATUS AND METHODS FOR PACKETIZED CONTENT DELIVERY OVER A BANDWIDTH-EFFICIENT NETWORK”, published Jan. 26, 2012, which is incorporated herein by reference in its entirety, may be utilized. As discussed therein, packetized content is provided to subscribers of an MSO network, via extant bandwidth-optimized network infrastructure. In one embodiment, various legacy and IP-capable user devices receive a list of available content, from which a user may select. The user's selection is transmitted to an intermediary device or proxy (such as gateway apparatus in the home, or a headend server), which formats the request according to a standardized protocol utilized by a server (e.g., the BSA/SDV server of FIG. 1c) for providing bandwidth-optimized delivery of content. The server uses one or more bandwidth optimization techniques to provide the requested content to the proxy. If the content is requested by an IP-capable device, the proxy formats the content using protocol translation. The formatted content is then delivered to the requesting IP-capable CPE. However, if the content is requested from a legacy device (e.g., a non-IP enabled STB), protocol translation is not necessary. In this manner, IP and legacy CPE can be freely intermixed in any proportion in the service group and home, the gateway or headend proxy being configured to deliver content regardless of the requesting device.

### Packetized Content Delivery Network—

While the foregoing network architectures described herein can (and in fact do) carry packetized content (e.g., IP over MPEG for high-speed data or Internet TV, MPEG2 packet content over QAM for MPTS, etc.), they are often not optimized for such delivery. Hence, in accordance with another embodiment, a “packet optimized” delivery network is used for carriage of the packet content (e.g., IPTV content). FIG. 1 d illustrates one exemplary implementation of such a network, in the context of a 3GPP IMS (IP Multimedia Subsystem) network with common control plane and service delivery platform (SDP), as described in U.S. Patent Application Publication No. 2011/0103374 filed on Apr. 21, 2010, and entitled “METHODS AND APPARATUS FOR PACKETIZED CONTENT DELIVERY OVER A CONTENT DELIVERY NETWORK”, incorporated herein by reference in its entirety. Such a network provides significant enhancements in terms of common control of different services, implementation and management of content delivery sessions according to unicast or multicast models, etc.; however, it is appreciated that the various features of the present disclosure are in no way limited to any of the foregoing architectures.

### Content Distribution Network Architecture—

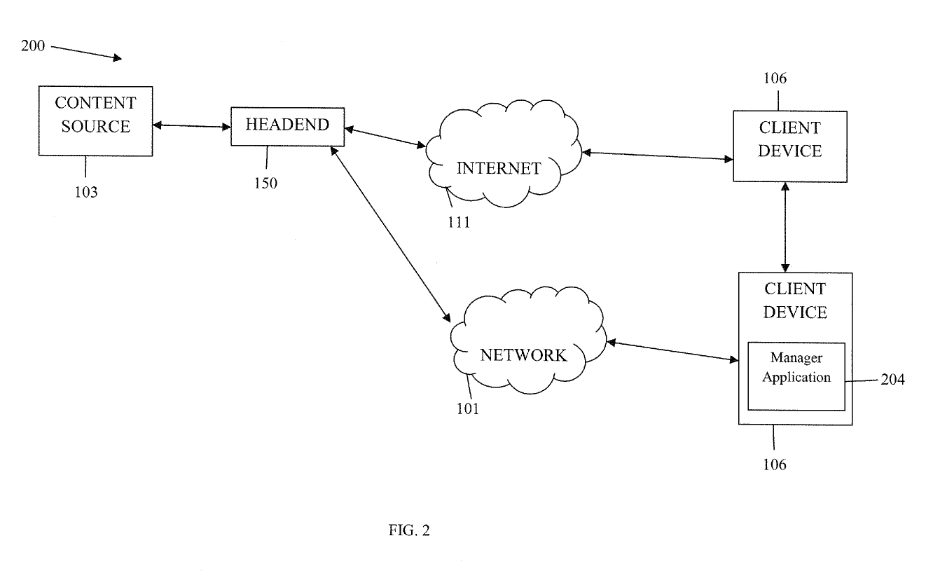

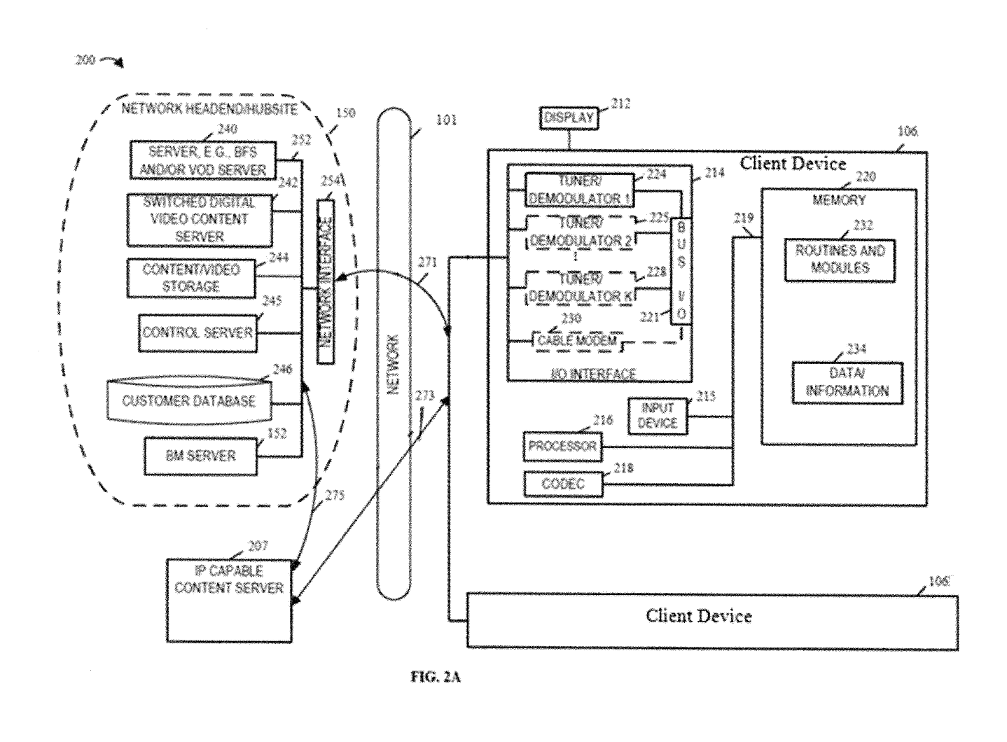

An exemplary content distribution network architecture is illustrated in FIG. 2, which operates in conjunction with the in-band and IP content systems described in FIGS. 1-1d above. The content distribution network architecture provides, inter alia, an architecture for switching content between at least two client devices.

The network 200 illustrated in FIG. 2 generally comprises one or more servers and a plurality of client devices 106. In one embodiment, the servers comprise the content source 103, and the headend 150. The content source 103 transmits content to the headend 150. As used herein, the term “content” is used collectively to refer to, a primary or originally requested content stream, and/or an alternate content stream (i.e., primary content other than that originally requested at the displaying device); one or both of the foregoing comprising the primary content with secondary or advertising content embedded therein. The primary or originally requested content may comprise audio, video and/or data relating to movies, television shows and/or live events which may be delivered via a broadcast, multicast, uniciast, or on-demand. The secondary or advertising content may comprise audio, video, and/or data relating to advertisements, which are displayed in content segments or blocks during the display of the originally requested (e.g., primary) content. The alternate content comprises primary content as that term is used above, which is different than the originally requested primary content. In other words, the alternate content is a viewer's second choice content, which in one embodiment is displayed at a second device while the first content is displayed at the first device. As noted above, the present disclosure relates to originally requested primary content and/or alternate primary content having secondary content embedded therein.

Referring back to FIG. 2, the network 200 may include additional servers, which receive the content (including primary, secondary and alternate content) from a content source and deliver it for processing at the headend 150. The processing of the content may include e.g., inserting a start and end markers in the content, calculating the duration of the content, and/or generating data files describing the content start and end times. The content is marked at its boundaries (such as with a start marker and a stop marker). As discussed in greater detail elsewhere herein, in one embodiment, the markers comprise well known SCTE-35 markers, however other indicators or flags may be used with equal success. For example, the content boundaries themselves may be utilized as content flags or markers which are sufficient for the purposes of the present disclosure. The markers may be embedded into the content prior to sending the primary content, the secondary content and the alternate content to the headend 150. Alternatively, a metadata file may accompany the content and describe the start and end times of the primary and secondary content within a single content stream.

The headend 150 transmits the content to the plurality of client devices 106 in communication therewith, via the bearer network 101 and/or the internet 111. Prior to transmitting the content to the client devices 106, the headend 150 may encrypt or otherwise protect the content. Content protection schemes are well known in the art and will not be discussed in further detail herein.

As illustrated, the client devices 106 are in communication with one another via e.g., a trusted domain, or other secure connection there between. In one embodiment, the client devices 106 may communicate via e.g., Multimedia over Coaxial Alliance (MOCA) compliant communication protocol. At least one client device is configured to run at least one manager application 204, which manages switching as discussed herein. In one embodiment, the manager application 204 enables switching of content displayed at a first device (i.e., primary or originally requested content) with content displayed at a second device (i.e., alternate primary content) when secondary content is encountered within the primary content stream. The switching may occur automatically at a start and/or end marker, or based on a user input. In one exemplary embodiment, a first device displays the originally requested primary content, when secondary content associated with the primary content being viewed on the client device 106 begins, the alternate content, which was previously being viewed by another (second) client device 106 is switched for display at the first device (and the secondary content may be displayed at the second device). The device on which the manager application 204 is run may be the first device (i.e., the device displaying the originally requested primary content prior to the switch), or the second device (i.e., the device displaying the alternate content prior to the switch). Although illustrated as the CPE 106 in communication with the headend 150 via network 101, it is appreciated that the manager application 204 may be run on any device in communication with the headend irrespective of the nature of the connection thereto.

In order for the manager application 204 to perform the automatic switch, the content is either marked with the markers (which indicate a start and end position within the content) during content processing at the headend, or the manager application 204 inserts markers into the content or otherwise identifies start and end times (such as based on the received metadata file) as the content is being displayed (i.e., in real time). In one variant, the manager application 204 monitors the content as it is being displayed at the first device 106 for a first marker which indicates that the primary content has ended and/or the secondary content has started. Once the manager application 204 detects the marker, the manager application 204 automatically switches the secondary content, on the first client device 106 with the alternate content on the second client device 106. This may be accomplished via a control message sent from the device on which the manager is run to the second device causing (i) retuning of the second device to the program or physical channel of the originally requested primary content, and (ii) retuning of the first device (which may be the device on which the manager is run) to the program of physical channel of the alternate content. Alternatively, the control message may direct the first and/or second client device to stream the content it is receiving directly to the other device (such as via the aforementioned MOCA protocol).

The manager application 204 then continues to monitor the content stream of the originally requested primary content for a second marker which indicates that the secondary content has ended and/or that the primary content has resumed. Monitoring thereof may be accomplished by background streaming the originally requested primary content stream (which is currently displaying secondary content) at the device on which the manager application 204 is run, receiving notification from the second device which is now displaying the originally requested primary content stream, and/or evaluating a metadata file associated with the content. Once the manager application 204 detects the second marker or is otherwise made aware that the secondary content within the originally requested primary content stream is ending, it causes a switch of the originally requested primary content back to the first client device 106, and the alternate content back to the second client device 106. The above-described process repeats each time a marker indicating beginning of secondary content within the originally requested primary content is detected.

It is appreciated that the manager application 204 may be pre-stored on the client device 106 on which it is run, or it may be downloaded thereto such as over the Internet 111 or network 101. It is further noted that the manager application 204 may comprise one or more portions each residing at different entities of the network 200. In one example, the manager 204 may comprise a distributed application. Accordingly, a co-called “thin” client may be employed to run a portion of the manager application 204, while an entity at the network headend 150 or edge 194 runs a complementary portion of the manager application 204.

In another embodiment, rather than automatic switching, the manager application 204 may, when detecting the markers, provide a notification to the user requiring a user input to switch the content being displayed at the client devices 106 (in the manner described above). According to this embodiment, when a first marker is encountered, the manager application 204 requests and receives user input regarding whether to perform the switch. Based on the input received, the manager application 204 switches the content between the client devices 106 and monitors for the next marker (i.e., the marker indicating that the secondary content within the originally requested primary content stream has ended or is about to end). Once the manager application 204 detects the second marker, a second notification is provided to the user indicating that the primary content has resumed or will resume momentarily. The user may either initiate the switch back to the originally requested primary content, or ignore the notification and continue viewing the alternate content at the first device.

It is appreciated that in the instance that the user ignores the second notification, or there is otherwise a delay in switching back to the originally requested primary content at the first device 106 (including during the automatic switching embodiment discussed above), the manager application 204 may cause either the first or the second device 106 to begin recording the originally requested primary content. This allows the user to view the originally requested primary content either beginning at the point where it resumed (after the secondary content ends), or to allow the user to delay viewing of the remainder of the primary content until a later time.

In yet another variant, the foregoing embodiments may be combined such that automatic switching may occur with respect to a first marker (i.e., the first instance secondary content occurs in the primary content stream), then the user may elect not to switch back to the originally requested primary content at the first device when the secondary content ends and instead, via a user input in response to a notification, remain viewing the alternate primary content at the second device.

It is further appreciated that, in the event that the user elects to continue viewing the alternate primary content at the first device and the originally requested primary content is recorded, the aforementioned switching may resume with respect to the alternate content and the recorded originally requested content. In other words, when secondary content is encountered during the playback of the alternate content at the first device 106, the system may automatically or in response to a user input, switch the display at the first device 106 back to the recorded version of the originally requested primary content. Such switching may occur at least until the viewer “catches up” to the broadcast of the originally requested primary content. As noted above, the content markers may comprise SCTE-35 markers as disclosed in American National Standard-ANSI/SCTE 35 2012, Digital Program Insertion Cueing Message for Cable, by © Society of Cable Telecommunications Engineers, Inc. 2012, which is incorporated herein by reference in its entirety. The SCTE-35 marker defines the cue messages that are embedded in the primary content and the alternate content. The SCTE-35 marker also defines upcoming splice points and other timing information. However, other mechanisms for indicating positions within both the primary content and secondary content for a switch may be utilized as well (including for example, segmenting the content, etc.).

FIG. 2a is another exemplary embodiment content distribution network architecture configured in accordance with the present disclosure. In this embodiment, the headend 150 or a hub (not shown) includes one or more servers and databases, such as the content server 240, the SDV content server 196, the content storage 244, the customer database 246, the billing module 152 and the control server 245. These components are coupled together by a local network 252, and the local network 252 is coupled to a network interface 254. The network interface 254 allows the components to communicate with one or more external networks, one or more servers and/or the client devices 106. In one variant, some of the components may reside outside the headend 150 (or hub) either as an individual entity of another network.

The content server 240 receives the content from the content source 103, and may inspect the content and insert the aforementioned markers as discussed above. The content server 240 may also receive initial requests for content, e.g., requests for a primary content stream and/or an alternate content stream, and deliver the requested content to the client devices 106 via the bearer network 101 and/or the Internet 111. In one variant, the content server 240 may be a broadcast file server (BFS) and is configured to deliver video on-demand content, e.g., the primary content, ordered by one or more of the client devices 106, which supports receiving content by tuning to the content server 240 broadcast stream, e.g., QAM broadcast stream. In another embodiment, the content server 240 accesses the content from the content storage 244 and transmits the content to the client devices 106 therefrom, via the bearer network 101 and/or the Internet 111.

Additionally, the control server 245 controls the operation of the various servers and databases 240, 196, 246, 152, within the headend 150. The control server 245 may receive requests from the client devices 106 and based on the request, communicate with the appropriate servers. For example, when the user requests for video on-demand content, e.g., the primary content, the control server 245 communicates with the customer database 246 and the billing module 152 to retrieve the user's information and update the billing information when necessary. The control server 245 then communicates with the content server 240 to transmit the requested video on-demand content to the client device 106.

In one variant, the control server 245 may send information regarding location, start, end, and/or duration of secondary content embedded within a requested primary content stream to the client device 106. The secondary content information is communicated by the control sever 245 to the client devices 106, via the bearer network 101 and/or the Internet 111. The control server 245, in one variant, may communicate the secondary content information to the client devices 106 by out of band signaling, e.g., over a DAVIS and/or DOCSIS communications channel. In another embodiment, the control server 245 may control the content server 240 and the SDV server 196 such as by embedding in one or more MPEG private data fields or specific queue tones into the primary content prior to delivery thereof to the client devices 106. In this embodiment, the client devices 106 may use the information to identify the start time and the end time of the secondary content.

The customer database 246 stores information about the user. The information stored includes a user's account information, and information regarding the client devices 106 which are registered or otherwise associated to the user. The user's account information may include such information as user account number, user subscription/service information, the capabilities of the client devices 106 registered thereto, and/or billing related information. Additionally, identification information regarding set-top boxes (e.g., DSTBs), gateways, modems, personal computers (PCs), and minicomputers, whether desktop, laptop, or otherwise, and mobile devices such as handheld computers, PDAs, personal media devices (PMDs), tablets, “phablets”, and smartphones registered or associated to the user may also be stored. Furthermore, the location of the client devices 106 and/or registration information may also be collected.

The SDV content server 196, as discussed above with respect to the “switched” networks embodiment, provides digital programming content, e.g., the primary content, the secondary content, and/or the alternate content, to one or more of the client devices 106 that supports receiving SDV content.

The billing module 152 as discussed above with respect to the network-side architecture embodiment, processes billing information corresponding to the users serviced by the headend 150.

In yet another embodiment, the IP content server 207 supplies content, e.g., the primary, the secondary and/or the alternate content in an IP format, to one or more client devices 106 served by the IP content server 207, via pathway 273 over the bearer network 101 and/or the Internet 111. The IP content server 207 may communicate with the components in the headend 150 and exchange information between each other, via a pathway 275, and with the client devices 106, via, a pathway 271, 273. In one embodiment, the IP content server 207 communicates with the network interface 254, via the pathway 275, to receive the requested content from the content server 240. In this embodiment, the IP content server 207 upon receiving the content formats the content into the IP format, inspects the content for markers and/or inserts markers where necessary. In another embodiment, the IP content server 207 receives the content from the content source 103, and formats the content into the IP format and inserts the markers, as discussed above, into the content. It will be appreciated that while the IP content server 207 is described generally in the context of communicating with the headend 150 and the components within the headend 150 (or hub), the IP content server 207 may be readily adapted to additionally include and perform the functions of any of the aforementioned components as well.

The client device 106 as illustrated in FIG. 2a, may include an input/output (I/O) interface 214 with at least one tuner/demodulator pair 224, an input device 215, a processor 216, a codec 218, and a memory 220, where the components are coupled together by a bus 219. In one variant, the I/O interface 214 may include a plurality of additional tuners and demodulator pairs 225, 228 and/or a cable modem 230. Each of the individual components will be described in greater detail below. Furthermore, at least one of the client devices 106 is configured to be coupled to a display 212 or have a display integrated therein. The client device 106 may also include a memory 220, which includes a control routine and modules 232 and a data/information 234 (which collectively form the manager application 204 discussed above with respect to FIG. 2). The control routine and modules 232 may include a plurality of routines and modules as described in greater detail below. The data/information 234 may include a content storage 420 as described in greater detail below.

In another embodiment, not shown, the manager application 204 comprises a headend or hub application. According to this embodiment, the manager application 204 includes a login and/or authentication module, which may require the user to input, a username and password, or a verification code that is based on a plurality of object coordinates or distorted text images provided to be presented on the display 212 of the client devices 106. By having the user login, the manager application 204 may monitor the content streams and for a user input, as discussed above, on the first client device 106 and the second client device 106 and perform the functions of any of the aforementioned features, as discussed elsewhere herein.

### EXEMPLARY METHODOLOGY

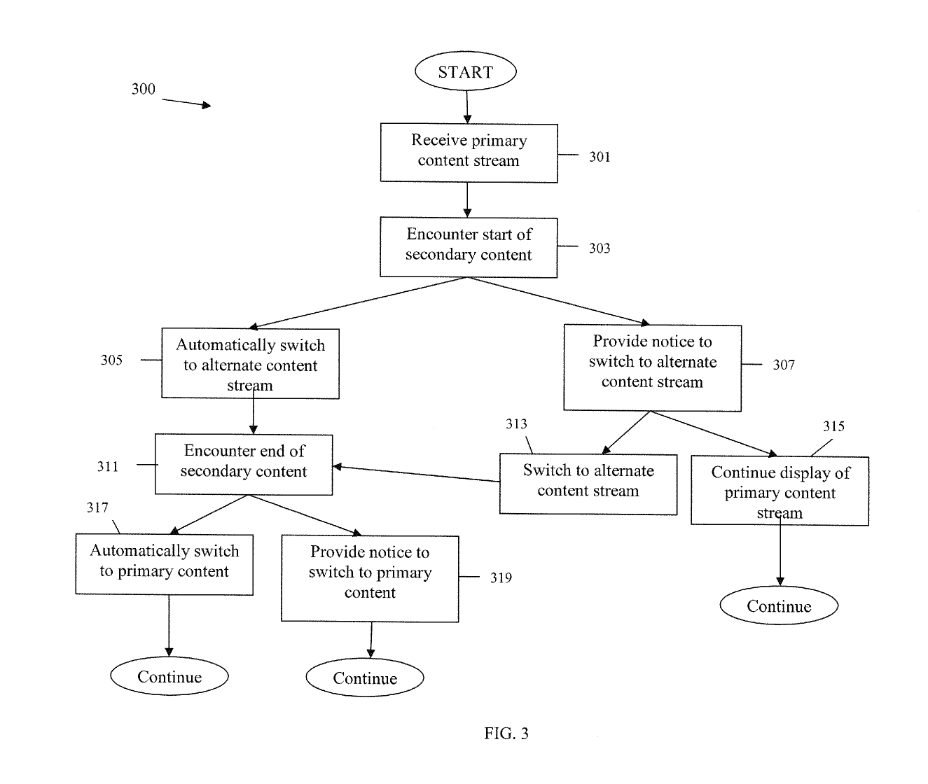

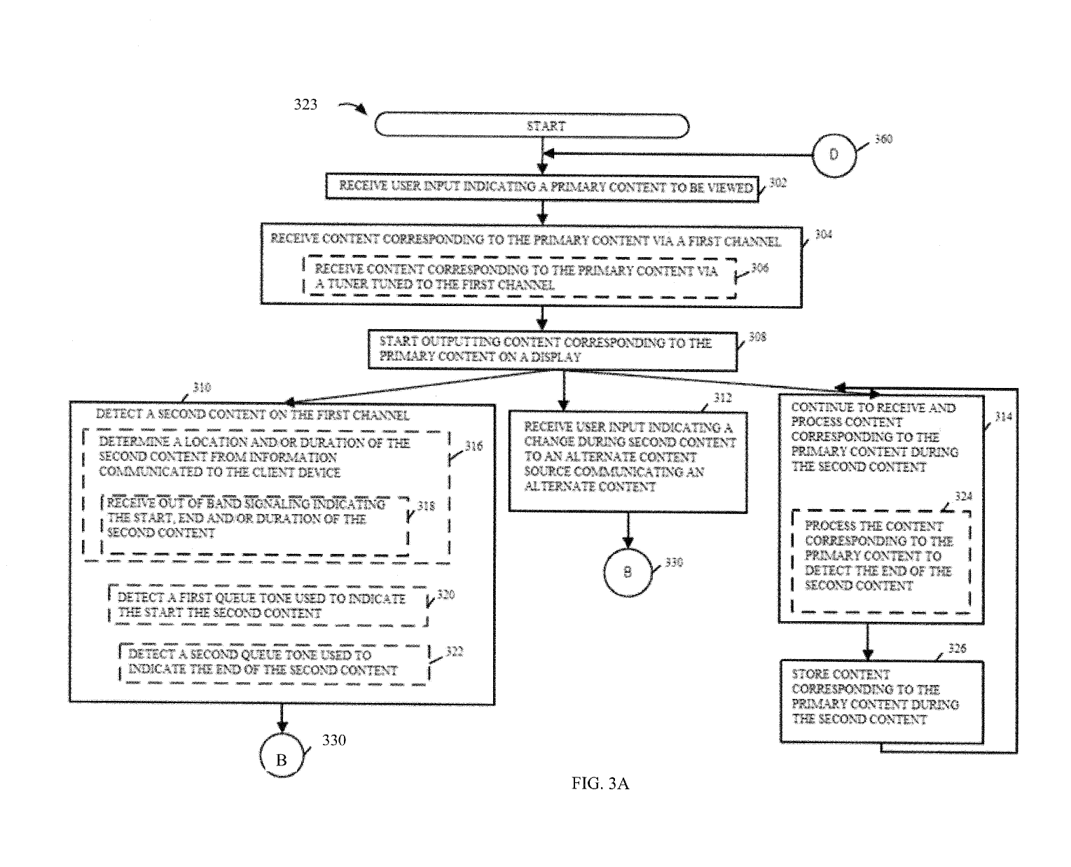

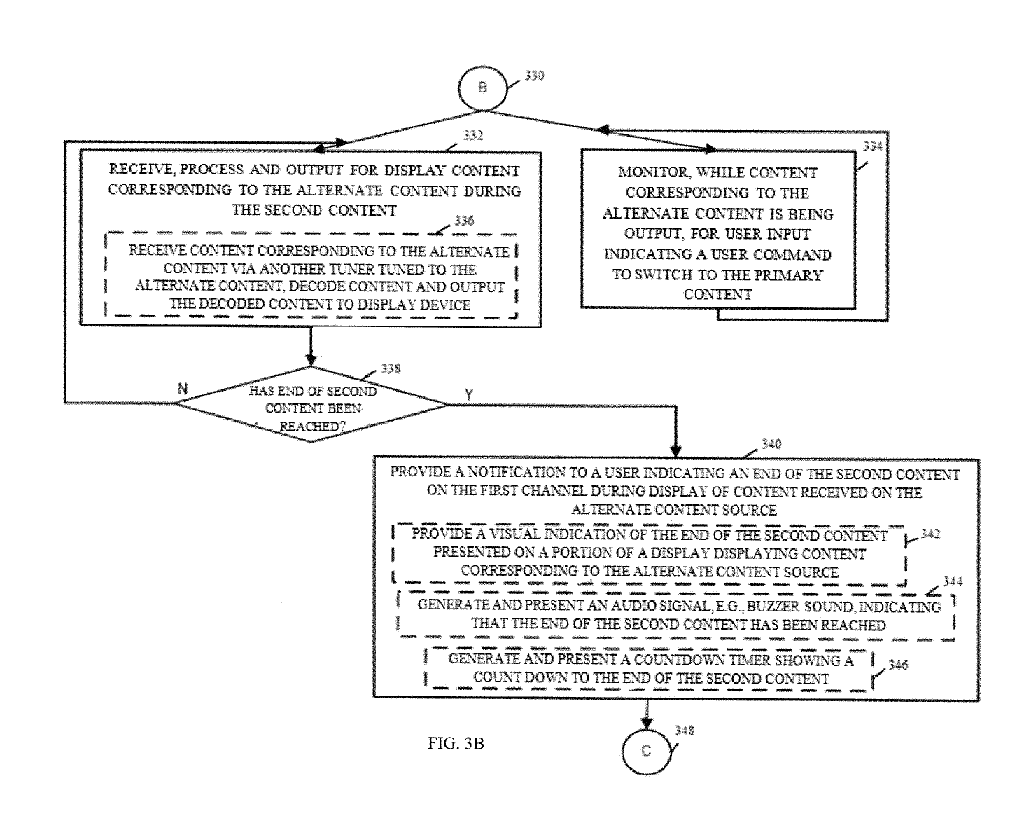

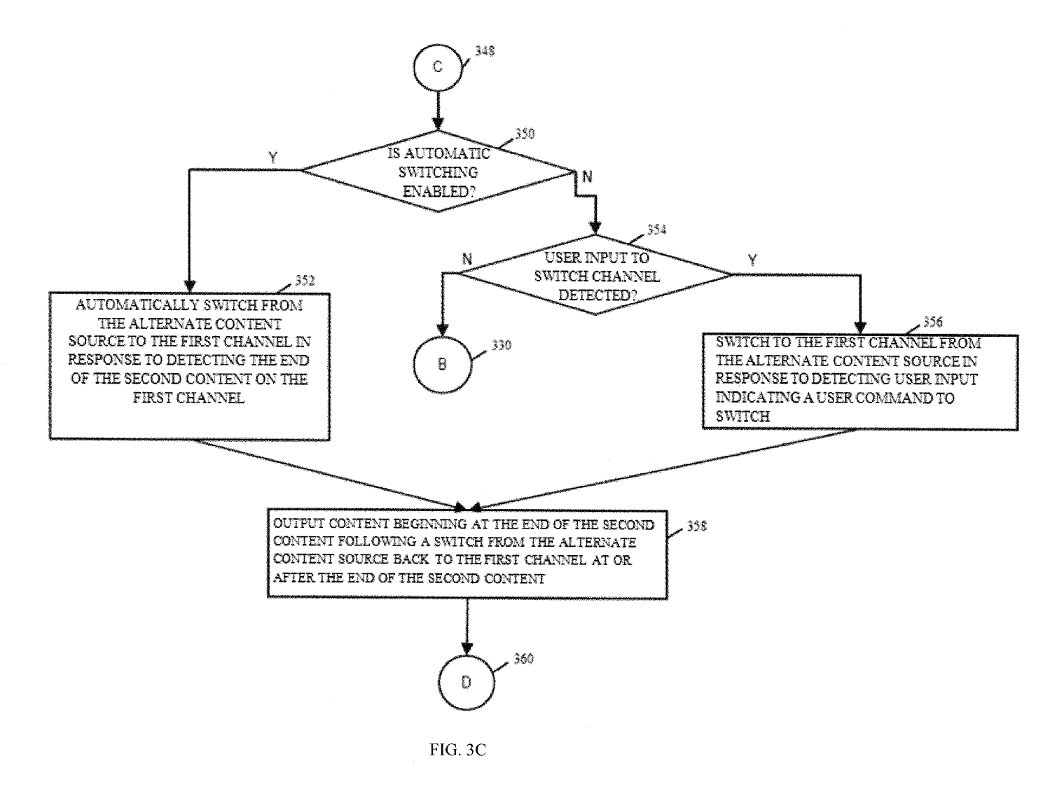

FIG. 3 illustrates an exemplary embodiment of a generalized method 300 for switching as discussed above.

Per step 301, the first client device 106 receives the primary content stream from the content server 240. In one embodiment, this may be accomplished directly from the network 101 (such as via a hub or headend entity), or content may be streamed from the Internet 111. The first client device 106 receives the primary content stream when the user requests for primary content on a first program channel.

Next, per step 303, the start of secondary content is encountered during the display of the originally requested primary content stream. The first client device 106 may determine the start of the secondary content by monitoring the content as it is being displayed at the first client device 106 for a first marker which indicates that the primary content has ended and/or the secondary content has started. Alternatively, the first client device 106 may utilize a metadata file describing the primary content stream to identify the beginning of secondary content therein.

Once the first client device 106 detects the secondary content beginning, the first client device 106, in one embodiment, automatically switches the secondary content, on the first client device 106 with the alternate content on the second client device 106 (step 305). In another embodiment, rather than automatic switching, the first client device 106 may, when detecting the markers or otherwise identifying secondary content, provide, per step 307, a notification to the user requiring a user input in order to perform the switch (in the manner described above). According to this embodiment, when the secondary content is encountered, the first client device 106 requests and receives user input regarding whether to perform the switch. Based on the input received, the first client device 106 either switches the content being displayed on the first and second client devices 106 (step 313), or does not perform the switch of content between the client devices 106 (step 315).

Next, per step 311, the manager application 204 monitors the originally requested primary content stream for an indication that the secondary content has ended and/or that the primary content has resumed (or will soon). In one embodiment, the monitoring may be accomplished by background streaming the originally requested primary content stream (which is currently displaying secondary content) at the first client device 106 while it is simultaneously displayed at the second client device 106, or receiving notification from the second client device 106 which is now displaying the originally requested primary content stream, and/or evaluating a metadata file associated with the content. Alternatively, the ending of the secondary content may be determined based on the timer mechanism discussed elsewhere herein.

Once, it is determined that the secondary content within the originally requested primary content stream is ending, the application 204 causes the first client device 106 to automatically switch the originally requested primary content stream back to the first client device 106, and the alternate content stream back to the second client device 106 (step 317). In an alternate embodiment, rather than automatic switching, the application 204 may instead provide, per step 319, a notification to the user indicating that the primary content has resumed or will resume momentarily. The user may either initiate the switch back to the originally requested primary content, or ignore the notification and continue viewing the alternate content at the first client device.

The above-described method repeats each time a marker indicating beginning of secondary content within the originally requested primary content is detected.

It is further appreciated that, as noted elsewhere herein, a headend entity and/or the client devices 106 may record one or both of the originally requested primary content stream and/or the alternate content stream to enable smooth transitions and provide a backstop where there is a delay in switching (either due to a manual input for a delay, or a system error).

Referring now to FIGS. 3a-3c, an exemplary embodiment of a method 323 for switching between different content according to the disclosure is shown.

Per step 302, as shown in FIG. 3a, a request for primary content on a first program channel is received at a first client device 106 and transmitted to the headend 150 or hub for servicing. In one embodiment, the request is made by the user via a selection from an electronic program guide. Alternatively, the request may be made via a user input of a channel number corresponding to the program channel associated with a primary content stream. The user may, in one embodiment, designate the selected primary content as “preferred” content via a client device 106 interface. The “preferred” content is therefore automatically prioritized for display at the first client device 106, i.e., when the secondary content ends, the preferred content is switched back to the first client device 106. Alternatively, the user may select content as “preferred” upon the first switching instance, i.e., when secondary content is first identified, a notification is provided to the user to select the content as “preferred”.

Next, per step 304, the client device 106 receives the primary content stream from the content server 240. In one embodiment, step 304 involves performing sub-step 306, wherein the client device 106 receives the primary content via a first tuner, e.g., the tuner/demodulator 224.

Next, per step 308, the client device 106 outputs the primary content to the display 212 associated with the first client device 106. The method 323 may then proceed to one of steps 310, 312 and/or 314 (as discussed).

At step 310, a it is determined that, within the primary content stream, the primary content has ended or is about to end and/or the secondary content has started or is about to start. The client device 106 or the headend 150 may monitor the content, as discussed above, to detect the marker indicative of the impending switch. Alternatively, sub-steps 316, 318, 320, and 322 may be utilized to determine a necessity for a switch.

In one embodiment, per sub-step 316, a location (start and end time) and/or duration of the secondary content within the primary content stream is determined and communicated to the client device 106 (such as from the headend 150 via metadata, as discussed elsewhere herein). Next, per sub-step 318, the client device 106 receives the information, which may include out-of-band signaling indicating the start and the end of the secondary content within the primary content stream.

Alternatively, the secondary content may be determined via a detection and/or identification of a first queue tone (or other marker) within the primary content stream which indicates the start of the secondary content therein (sub-step 320). The client device 106 may then detect a queue tone (or other marker) corresponding to the end of the secondary content (sub-step 322). In one example, the client device 106 may use a timer to detect when e.g., approximately 3 minutes worth of time, including multiple queue tones have passed. According to this variant, the counting of queue tones is open looped, and the client device 106 may predict with reasonable certainty when the primary content has resumed based on an expected duration of the secondary content including an assumed 3 minutes worth of secondary content at each advertisement break. Upon completion of step 310 and/or sub-steps 316, 318, 320, 322 the method 323 proceeds to step 332.

Another embodiment is discussed at step 312. According to this embodiment, a request to switch from the primary content stream to the alternate content stream is received by the manager application 204 (such as at the client device 106 or the headend 150), when the secondary content has started. The viewer requests to switch via a remote control device, or another interface (such as a touch screen, voice activation, etc.). Similarly, the user input may be received in response to a notification presented to the user that the secondary content is forthcoming. Upon receiving the aforementioned indication, the method 323 precedes at B 330.

Simultaneously or in parallel to the embodiments discussed above with respect to steps 310 and 312, per step 314, the first or the second client device 106 continues to receive and process the primary content stream throughout the duration of the secondary content. In one variant, sub-step 324, the content processing may comprise detecting the end of the secondary content, such as via a detection of an end marker within the secondary content, or via metadata received by the manager application 204. Additionally, as discussed at step 326, the primary content stream is stored in a storage apparatus, e.g., a storage buffer, located in the client device 106. Recording or storage of the primary content stream may begin when the secondary content has started, or be persistent throughout (i.e., the primary content stream may be held in a temporary storage so that it is available if needed without being specifically requested). This allows for reduced switching delays as described in greater detail below. As indicated by a loopback following step 326, the steps 314 and 324 in one embodiment are performed on an ongoing basis. Thus, when the secondary content is detected and/or when the user changes to the alternate content, the client device 106 continues to receive, process, and store the primary content stream while the client device 106 displays the alternate content stream on the display apparatus 212.

Referring now to FIG. 3b the method 323 continues to step 332. As indicated, the first client device 106 receives the alternate content stream. In one embodiment, the content stream is received from the headend 150 via the network 101 or Internet 111, alternatively, the content may be shared (such as via a peer-to-peer transfer and/or the establishment of a trusted domain) from the second client device 106. The first client device 106 then processes the alternate content stream and outputs the content thereof to the display 212. In one variant, a headend 150 entity may process the alternate content prior to delivery thereof to either the first or second client device 106 in order to e.g., insert content markers and/or generate descriptive (metadata) files regarding the content for use in the present system. In one exemplary embodiment (sub-step 336), the client device 106 receives the alternate content stream via a second tuner, e.g., tuner/demodulator 226, tuned to the alternate content source. The second tuner demodulates the alternate content stream and transmits the content thereof for display at the display device 212.

Alternatively, in step 334, which is primarily a manual method for content switching, the client device 106 monitors for a user input indicating a desire to switch the originally requested primary content back to the first device 106 (and the alternate content back to the second client device 106). The user input may be received prior to or directly the ending of the secondary content within the originally requested primary content, whether in response to a notice displayed to the user or completely user initiated.

Referring now to step 338, during the delivery and display of the alternate content stream at the first client device 106, the manager application 204 (whether running at the first or the second client device 106) determines whether the secondary content encountered in the originally requested primary content stream has ended or is nearing an end. When the secondary content has not ended the method 323 continues at step 332 (where the first client device 106 continues to receive, process, and output the alternate content stream). When the secondary content has ended, the method 323 proceeds to step 340.

In one embodiment, during the display of the alternate content stream at the first client device 106, the manager application 204 determines whether the alternate content stream has encountered secondary content. When this occurs, the manager application 204 may automatically switch back to the primary content stream (irrespective of whether the primary content stream is currently displaying primary or secondary content). In addition, the manager application 204 may provide a notification (as discussed elsewhere herein) displayed on at least a portion of the display of the first client device 106 which notifies the viewer that the manager application 204 will perform the switch discussed above and enable the viewer to elect whether or not to have the switch performed. In yet another embodiment, the viewer may override the switch and elect, via the notification screen, third content which the viewer would prefer to view when the alternate content stream reaches secondary content.

In one variant, the manager application 204 may further provide a predetermined list of additional content to the user. The list may be generated by the user via a selection from an electronic program guide (EPG) when the user is also selecting the primary content stream and the alternate content stream, or may be generated by the manager application 204 or other headed entity. Additionally, or alternatively, he list may be generated by either a default setting stored in the device memory 220 or by the manager application 204 accessing the user's settings stored in the device memory 220.

The manager application 204 may also provide the user a notification, providing the user with a list of options. The list of options may include the predetermined list and/or a request for a user input to switch the content being displayed at the client devices 106 (in the manner described above). In one implementation, the user may ignore the notification and continue viewing the alternate content stream at the first client device 106 or the user may select one of the available options from the aforementioned list of options.

In another embodiment, the manager application 204 may comprise a recommendation engine configured to identify and recommend additional alternative content streams to the user when the secondary content in the alternate content stream has begun. In one implementation, the apparatus and methods of co-owned, co-pending U.S. patent application Ser. No. 12/414,576 filed on Mar. 30, 2009 and entitled “RECOMMENDATION ENGINE APPARATUS AND METHODS”, which is now published as U.S. Patent Application Publication No. 2010/0251305, and which is incorporated herein by reference in its entirety, are utilized. As discussed therein, a mechanism is provided which is configured to learn (and unlearn) a user's preferences based on actions taken with regard to the types of content selected (both primary content and alternate content).

In yet another embodiment, the manager application 204 may continue to display the alternate content stream on the first client device 106, while the manager application 204 (whether running at the first or the second client device 106) determines whether the secondary content encountered in the originally requested primary content stream has ended or is nearing an end and make a determination of e.g., whether to switch early based on a predetermined time threshold.

At step 340 a notification is provided to the user during the display of the alternate content. The notification indicates that the secondary content of the originally requested primary content stream has ended (or is about to end). In one embodiment, sub-step 342, the notification is a visual indication that the secondary content has ended (or is about to end). The visual indication is displayed on at least a portion of the display of the alternate content stream at the display apparatus 212. Alternatively, or in addition, the notification may comprise an audio signal, e.g., buzzer sound, or other auditory cue including a statement to the viewer (step 344). The audio signal may be generated in real time by at least one of the client devices 106, or alternatively may comprise a pre-recorded sound or message either provided by the network or pre-stored on the device. In one variant, the audio signal and visual indication may be provided simultaneously. In a further embodiment, sub-step 346, the notification may comprise a countdown timer showing the remaining time left before the secondary content ends. The countdown timer may be displayed at a non-intrusive portion of the display of the alternate content stream throughout the display thereof, and/or it may include features such as flashing, changing colors, etc. upon reaching or nearing the end of the secondary content. The timer may be generated by the client device 106 based on the information received from processing entities at the headend or hub (as discussed above).

Referring now to FIG. 3c, at step 350, the manager application 204 (either at the first or second client device 106 or the headend 150) determines whether the user has enabled automatic switching. This may be determined by e.g., accessing the user's settings stored in the device memory 220. In one variant, automatic switching of the type described herein may be a default setting of the device 106 on which the manager application 204 is run. In another variant, the user can enable one or both of automatic switching and/or receiving notifications regarding the start/end of the secondary content.

In one embodiment, when it is determined (at step 350) that the automatic switching is enabled, the manager application 204 causes the content to automatically switch back (step 352). In one exemplary embodiment, the system automatically switches the alternate program stream back to the second client device 106 (such as by causing it to re-tune to the program channel of the alternate program stream), and switches the originally requested primary content stream back to the first client device 106 (either by re-tuning to its program channel, or by accessing a recorded version of the primary content stream from storage, as discussed elsewhere herein). In one variant, automatic switch may occur after reaching a predetermined period of time, as discussed above (despite whether end of the secondary content has been reached).

In another embodiment, when it is determined that the automatic switching is not enabled, the manager application 204 determines whether an input from the user to switch back to receiving the originally requested primary content stream at the first client device 106 has been detected (and therefore also switch the alternate content stream back to the second client device 106). When a user input has not been received, the method 323 proceeds at B 330. Alternatively, when a user input is detected, the method 323 proceeds to step 356. At step 356, the manager application 204 causes the originally requested primary content stream to be switched back to the first client device 106 (and the alternate program stream back to the second client device 106).

Next, per step 358 the client device 106 outputs the primary content stream to the display device 212. In one embodiment, the primary content stream begins at the precise point that the secondary content ends. In another embodiment, when there has been a delay in receiving the user input or in switching the content, the headend 150 and/or either of the client devices 106 may begin recording the primary content. The method 323 repeats at D 360.

### Exemplary User Device—

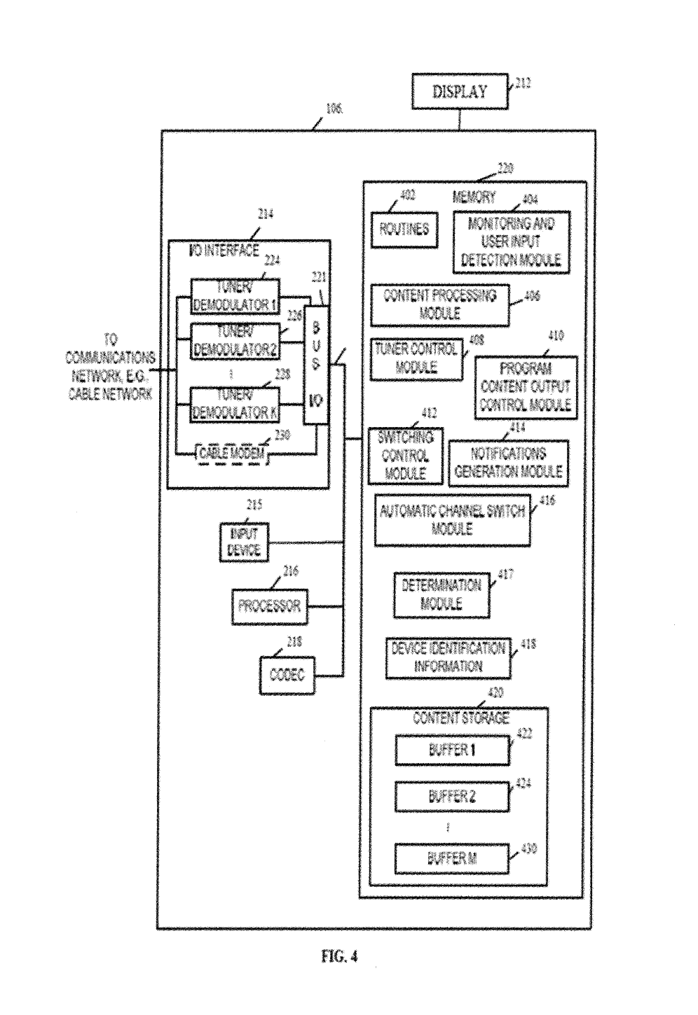

An exemplary client device 106 useful with the present disclosure is illustrated in FIG. 4. The client device 106 may include an I/O interface 214, with at least one tuner/demodulator pair 224, an input device 215, a processor 216, a codec 218, and memory 220, each coupled to one another via a bus 219. The components 214, 215, 216, 218, and 220 may exchange data and information with each other over the bus 219. The I/O interface 214 in addition may include additional tuner/modulators 226, 228 and a cable modem 230, which are coupled to the bus 219 via the bus interface 221.

Additionally, the I/O interface 214 receives and transmits content and/or data to and from various headend or hub entities (e.g., the content server 240, the SDV server 196, and/or the IP content server 207, the content storage 244, the user database 246, and/or the control server 245). The client device 106 may also utilize the I/O interface 214 to exchange information with other client devices 106 and entities outside of the managed network 200. The I/O interface 214 may communicate over the bearer network 101, and/or the Internet 111. Additionally, the I/O interface 214 may include an infrared (IR) signal receiver and/or a radio interface for receiving the user input.

The tuner/demodulators 224, 226, 228 are configured to tune to a frequency band where each of the tuner/demodulators 224, 226, 228 may receive and demodulate the content and data received, via the headend 150, hub, and/or another client device 106. For example, the tuner/demodulator 224 may be tuned to a frequency band, where the tuner/demodulator 224 receives the primary content stream, while the tuner/demodulator 226 may be tuned to a frequency band, where the tuner/demodulator 226 receives the alternate content stream. In another embodiment, when the content is sent from the IP content server 207, the content is received by the cable modem 230 before being sent to one of the tuner/demodulators 224, 226, 228 to be demodulated. Once the content has been demodulated the content is sent either to at least one of the modules located in the memory 220 for further processing or to the display 212 to be outputted.

In the illustrated embodiment, the client device 106 further comprises an encoder/decoder (labeled “codec 218”), which encodes and/or decodes received content. For example, the encoder decoder may decode content from digital data format to a format capable of being displayed at the display 212 or other device. Once the content has been decoded, the content is sent either to at least one of the modules located in the memory 220 for further processing or to the display 212 to be outputted.

The input device 215 comprises a user input for receiving requests. The apparatus may include a keyboard, touch screen, mouse pad, etc., which are either integrated into the client device 106 or a separate entity capable of communicating the user input 215. In one variant, the input device 215 may include a microphone, which receives and processes voice commands. The voice commands may comprise the user input to perform the herein disclosed switching.

The processor 216, or central processing unit (CPU), controls the general operations of the client device 106 such as outputting content to the display 212, outputting notifications to the user. The processor is further configured to run the modules and routines stored in the device memory 220.

The routines 402 are configured to control the operation of the various modules within the client device 106. The routines 402 may receive requests from the user and based on the request, communicate with the appropriate modules. For example, when the user requests for content, e.g., the primary content, via the program guide, various ones of the routines 402 communicate with the monitoring and user input detection module 404 to detect the user input, the tuner control module 406 to tune to the frequency band to receive the content, and the program content output control module 410 to output the content, e.g., the primary content, to the display 212. In another example, when the user requests for video on-demand content, e.g., the primary content, the routines 402 communicate with the customer database 246 and the billing module 152 to retrieve the user's information and update the billing information when necessary.

The routines 402 then communicates with the content server 240 to transmit the requested video on-demand content and the tuner control module 406 to tune to the frequency band to receive the video on-demand content. The routines 402 then also communicates with the program content output control module 410 to output the video on-demand content, to the display 212.

The routines 402 may also receive information regarding the program guide, via the headend 150. The routines 402 then translate the received information into a format, which the program content output control module 410 may use to display the program guide on at least a portion of the display 212.

The routines 402 may further receive information regarding location, start, end, and/or duration of secondary content embedded within the requested primary content stream via the headend 150. The routines 402 then translate and send the received information in a format, which the switching module 412, the automatic channel switching module 416, and the determination module 417 may use as described below.

In yet another embodiment, the routines 402 may communicate with the tuner control module 406 to determine a tuner contention resolution when there is a resource contention among the tuner/demodulator pairs 224, 226, and 228. In one implementation, the routines 402 instruct the tuner control module 406 to retune the tuner/demodulator pair, which has been switched to the least by the client device 106 to a different frequency based on a determination of an additional alternative content that the user may prefer (such as based on a recommendation by the aforementioned recommendation engine) or to one of the additional alternative contents include on the predetermined list as described above.

The monitoring and user input detection module 404 is configured to monitor and detect the user input, which is received by the client device 106. The user input may be entered directly into the client device 106, or via a remote control device. In one variant, the user input is received via the I/O interface 214, and then transmitted to the monitoring and user input detection module 404 for processing. The monitoring and user input detection module 404 may also directly receive the user input, which indicates as discussed above, a request to switch. Additionally, the monitoring and user input detection module 404 may monitor the content streams for a marker or user input indicating secondary content.

In one variant, when the user input is detected the monitoring and user input detection module 404 may present a list of options to the user. The list of options may include, enabling automatic switching, enabling the notifications as discussed above, and/or selecting a modified version of the alternate content. The modified version of the alternate content may be an abridged version and/or compilation, e.g., highlight reel. The abridged version allows the user to view the significant and/or interesting parts of the alternate content that the user missed while watching the primary content. The list of options may be presented to the user for a set period of time or until the user makes a selection. Once the user has made a selection the monitoring and user input detection module 404 may store the user input and/or selection as a user's preferred action in the memory 220. The monitoring and user input detection module 404 may also forward the user input to the notifications generation module 414 and/or the automatic switching module 416 to execute the appropriate action when the secondary content ends or is about to end.

The monitoring and user input detection module 404 may also receive and process the content and/or data received from the headend 150, hub, and/or the IP content server 207. The processing of the content, as discussed above, may include detecting the start, end and/or duration of the content.

The tuner control module 406 controls the tuner/demodulator pairs 224, 226, and 228 by providing information and/or parameters to the tuner/demodulator pairs 224, 226, 228 to tune to the frequency band, to receive the content, as discussed above. Thus, the tuner control module 406 may control one or more of the tuner/demodulator pairs 224, 226, 228 to tune to a frequency corresponding to the primary content and/or the alternate content. In other words, the tuner control module 406 manages the allocation of the different tuner/demodulator pairs 224, 226, 228 for tuning to the different content sources e.g., the primary content source and the alternate content source, when the user desires to switch the contents between the client devices 106 as discussed above. In one variant, the tuning information and/or parameters are sent from the headend 150 and/or other servers supplying the content to the tuner control module 406.

The program content output control module 410 is configured to control the presentation of the content to the display 212. For example, during operation when the user is tuned to the primary content, the program content output control module 410 controls the client device 106 to output the primary content.

The switching module 412 is configured to switch the content as discussed above. In one example, when the switching module 412 detects the user input and/or receives an indication that the marker has been detected, the switching module 412 switches the content between the client devices 106 and instructs the content output control module 410 to output the content, e.g., the alternate content, to the display 212. In one variant, when there is a delay in switching the content, as discussed above, the switching module 412 may either begin recording the primary content or provide a notification to the headend 150 or the memory 220 to begin recording the primary content. In this variant, the switching module 412, instructs to the program content output control module 410 to output the primary content from where the recording began.

The notifications generation module 414 is configured to generate and provide notifications to the user, as discussed above.

The automatic channel switching module 416 may monitor the content for the marker, which indicates that either the primary content has ended or is about to start, and/or that the secondary content has ended or is about to end. Upon the detection of the marker the automatic channel switching module 416 either automatically switches the content between the client devices 106, and instructs the program content output control module 410 to output the content or the automatic channel switching module 416 transmits to the switching module 412 to switch the contents between the client devices 106. The automatic channel switching module 416 may be enabled by the user in one embodiment.

The determination module 417 is configured to detect and determine the duration of the content. In one embodiment, the determination module 417 determines the duration of the secondary content. The determination module 417 may determine the duration of the content based on the detection of the marker, as discussed above, indicating the start and/or the end of primary or secondary content within a content stream. In another embodiment the determination module 417 may determine the duration of the content based on either the detection of queue tones as discussed above, or detecting out-of-band signaling indicating the start and the end of the content, e.g., DAVIC and/or DOCSIS communicated information, via the headend 150 or hub.

The device identification information module 418 may include, e.g., Media Access Control (MAC) address of the client device 106, or another identifier identifying the client devices 106, which allows the client devices 106 to operate in conjunction with the in-band and IP content systems described in FIGS. 1-1d and the headend 150 described in FIGS. 2-2a above.

The content storage 420 may include a plurality of buffers for the storage of the content received via the tuner/demodulator pairs 224, 226, 228. The content storage 420 includes buffers 1 420 through M 430. In one embodiment, there are as many buffers as there are tuner/demodulator pairs in the client device 106. In another embodiment, when there are less buffers then there are tuner/demodulators pairs, the content storage 420 or the tuner control module 408 may assign multiple tuner/demodulators pairs to each of the buffers.

It will be appreciated that one or more of the various modules, as discussed above, may work in coordination, e.g., modules being merged to perform a function, to produce a desired output in accordance with the present disclosure.

### Additional Delivery Mechanisms—

In one embodiment, the apparatus and methods of co-owned, co-pending U.S. Patent Application Publication No. 2013/0046849 entitled “APPARATUS AND METHODS FOR REDUCED SWITCHING DELAYS IN A CONTENT DISTRIBUTION NETWORK” published on Feb. 21, 2013, which is incorporated herein by reference in its entirety, is utilized in conjunction with the present disclosure. As discussed therein, the network 200 is configured to carry Internet Protocol (IP) based content, and switching delays are reduced by caching “background” content (i.e., content which it is anticipated the viewer will request next) at reduced quality and/or resolution. The provided background content, e.g., primary and/or alternate, anticipates content switches and, when a content switch is made to the background content, the selected content, e.g., primary or alternate, is immediately increased in quality and/or resolution, and provided to the requesting client device 106 along with updated background content. In the exemplary implementation, the network 200 includes a manager entity (such as e.g., the manger application 204), which manages which and how many and which background content is cached. The delivery of background content may be based on any number of different parameters or considerations, such as for example the user or client device 106 behavior and patterns, user preferences or “favorites”, bandwidth considerations, time of day, and/or subscription level. Information or metadata enabling the manager entity to make such determinations is stored at a database (such as e.g., the customer database 246) accessible by the entity. Additionally, the manager entity may classify each of the client devices 106 in the network 200 according a status thereof. When a particular client device 106 is in one status or mode, it has appropriate background content cached therefore. However, when the client device 106 is in another status or mode, it will no longer have background content caching. The manager entity may make a determination of a status or mode of each of the client devices 106 based on e.g., time of day, type of content, recentness of activity (i.e., content switch requests) on the client device 106 (or associated devices), bandwidth availability, or subscription level, or a combination of one or more of the foregoing. According to this embodiment, an alternate content stream may be cached in the background for use in switching as discussed herein.

It will be recognized that while certain aspects of the present disclosure are described in terms of a specific sequence of steps of a method, these descriptions are only illustrative of the broader methods, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the present disclosure and claimed herein.

While the above detailed description has shown, described, and pointed out novel features of the disclosure as applied to various embodiments, it will be understood that various omissions, substitutions, and changes in the form and details of the device or process illustrated may be made by those skilled in the art without departing from the ideas set forth herein. The foregoing description is of the best mode presently contemplated of carrying out the disclosure. This description is in no way meant to be limiting, but rather should be taken as illustrative of the general principles of. The scope of the disclosure should be determined with reference to the claims.

1. A method for managing content in a content distribution network, said method comprising:
receiving a user selection a content stream comprising primary and secondary content;
outputting said primary content to a rendering apparatus;
receiving an input indicating a content switch during rendering of said secondary content to alternate content; and
switching automatically from said alternate content back to said primary content in response to detecting an end of said secondary content.

2. The method of claim 1, further comprising:
receiving said alternate content from a second apparatus;
substituting said secondary content for said alternate content; and
outputting said alternate content to said rendering apparatus.

3. The method of claim 2, wherein said act of substituting said secondary content for said alternate content further comprises transmitting said secondary content to said second apparatus.

4. The method of claim 2, wherein said act of receiving said alternate content from said second apparatus further comprises processing said alternate content to a format which may be outputted to said rendering apparatus.

5. The method of claim 1, wherein said method further comprises:
receiving said primary content and said secondary content via a first tuner; and
processing said primary content and said secondary content to detect a start of said secondary content.

6. The method of claim 5, wherein said act of processing said primary content and said secondary content to detect said start of said secondary content further comprises processing said secondary content to detect said end of said secondary content.

7. The method of claim 2, further comprising:
transmitting said alternate content to said second apparatus when said secondary content has ended; and
outputting said primary content to said rendering apparatus at said end of said secondary content.

8. A rendering apparatus configured to switch between first and second primary content, said rendering apparatus comprising:
a first interface configured to communicate with a network;
a storage apparatus; and
a processor configured to execute at least one computer program, said at least one computer program comprising a plurality of instructions which are configured to, when executed:
cache first primary content, said first primary content being selected by a second rendering apparatus;
switch from secondary content within a second primary content stream to said cached first primary content;
transmit said secondary content to said second rendering apparatus;
increase a quality of said cached first primary content;
render said first primary content at said increased quality; and
switch automatically from said first primary content back to said second primary content stream in response to detection of an end of said secondary content within said second primary content stream.

9. The apparatus of claim 8, wherein said network comprises a radio-frequency transport, and said first interface further comprises at least one tuner configured to tune to a first frequency within said transport to receive said second primary content stream and said secondary content within said primary content stream from said network.

10. The apparatus of claim 9, wherein said first interface further comprises a second tuner configured to tune a second frequency to receive said first primary content from said second rendering apparatus.

11. The apparatus of claim 8, wherein said plurality of instructions are further configured to, when executed, process at least a portion of said second primary content stream to determine said end of said secondary content.

12. The apparatus of claim 11, wherein said plurality of instructions are further configured to, when executed, transmit said first primary content to said second rendering apparatus when said secondary content has ended, and output said second primary content stream at said end of said secondary content.

13. The apparatus of claim 8, wherein said apparatus further comprises at least one buffer configured to store said second primary content stream not being rendered during said first primary content.

14. The apparatus of claim 8, wherein said plurality of instructions are further configured to, when executed provide, substantially contemporaneous with said automatic switch, notification to a user of said switch, said notification comprising a visual indication presented on a portion of a display of said first rendering apparatus, wherein said visual indication comprises information regarding said switched-to content.

15. A computer readable apparatus having a storage medium comprising a plurality of instructions which are configured to, when executed:
receive user selected programming content, said user selected programming content comprising primary content and secondary content;
output said primary content to a rendering device;
receive a first input trigger configured to cause a content switch, said first trigger being received during a display of said secondary content, and said switch comprising a switch to a display of an alternate content located on a second apparatus, and said alternate content comprising primary and secondary content contained therein;
cause transmission of said secondary content to said second apparatus;
receive said alternate content from said second apparatus;
cause said rendering device to display said alternate content;
receive a second trigger configured to cause a second content switch, said second trigger configured to indicate a start of said secondary content within said alternate content, and said switch comprising a switch to display one of a plurality of identified additional alternative content, said additional alternative content being identified based on actions taken by said user with regard to previously selected content;
cause said rendering device to switch from said display of said one of said plurality of identified additional alternative content back to said programming content in response to a detection of an end of said secondary content within said programming content.

16. The apparatus of claim 15, wherein said plurality of instructions are further configured to, when executed, process said programming content to determine when said secondary content starts and ends.

17. The apparatus of claim 16, wherein said plurality of instructions are further configured to, when executed, cause transmission of said alternate content to said second apparatus when said secondary content within said programming content has ended, and output said primary content at said end of said secondary content.

18. The apparatus of claim 17, wherein said plurality of instructions are further configured to, when executed, record said primary content when transmission of said alternate content is delayed, said recordation configured to start at said end of said secondary content within said programming content.

19. The apparatus of claim 18, wherein said plurality of instructions are further configured to, when executed, output said primary content to be displayed, said output configured to start at said end of said secondary content.

20. The apparatus of claim 15, wherein said plurality of instructions are further configured to, when executed, provide a notification to a user of said switch between said alternate content and said primary content.

21. A method for managing content in a content distribution network, said method comprising:
receiving a user selection for programming content comprising primary and secondary content;
outputting said primary content portion of said programming content to a rendering apparatus;
receiving an indicator of said secondary content within said programming content, said indicator causing a content switch to alternate content;
outputting said alternate content to said rendering apparatus, said alternate content comprising at least a compilation of portions of a plurality of second programming content; and
providing notification to a user indicating an end of said secondary content portion of said programming content during said act of outputting of said alternate content.

22. The method of claim 21, wherein said provision of said notification provides said user with an opportunity to decide whether to a) continue to view said alternate content, or b) return to viewing said primary content.

23. The method of claim 22, wherein said providing notification comprises providing said user with a visually cognizable message or display element via at least said rendering apparatus.
